(19) United States
(12) Patent Application Publication
(10) Pub. No.: US 2021/0224027 A1
(43) Pub. Date: Jul. 22, 2021

(54) DIGITAL MEDIA APPARATUS

(71) Applicants: Kelly George Wilson, Qualicum Beach (CA); Kevin Powley, Sault Ste. Marie (CA)

(72) Inventors: Kelly George Wilson, Qualicum Beach (CA); Kevin Powley, Sault Ste. Marie (CA)

(21) Appl. No.: 16/747,912

(22) Filed: Jan. 21, 2020

(51) Int. Cl. G06F 3/16

(52) U.S. Cl. CPC G06F 3/165

(57) ABSTRACT

A digital media apparatus that includes a player and media storage member wherein the apparatus facilitates controlled transmission of digital audio data stored on the media storage member. The player of the present invention includes a receiving area configured to releasably receive and retain a media storage member. The media storage member is operably coupled to the player utilizing a plurality of electrical contacts. The housing of the media storage member has a recess in the upper surface thereof that is configured to receive a graphic art member. The graphic art member is backlit by an illumination element disposed in the housing of the media storage member. A first set of control switches and second set of control switches are located in the media storage member and receiving area respectively and place in an operational mode the apparatus to permit playing of the audio files.

### FIELD OF THE INVENTION

The present invention relates generally to digital media distribution and collection, more specifically but not by way of limitation, a digital media player and mateable digital content storage member that are configured to provide a technique of purchasing, collecting and playing digital content on the digital media player of the present invention.

### BACKGROUND

The human trait of collecting is a ubiquitous characteristic that over the centuries has proven to be both culturally and gender agnostic. For hundreds of years humans have collected items of interest and value to the individual. The categories of items range broadly from religious artifacts, sports memorabilia and countless others. Another characteristic that has permeated human culture is the love of music. Music has been an integral part of all cultures for thousands of years. A plurality of alternate types of music are associated with various cultures and this music has been created on various types of instruments. In the modern era, the recording and collecting of this music has been engaged in by much of our society. Over the past half decade, the media type on which the created music was stored, distributed and collected has progress from magnetic tape to vinyl to compact disc and now electronic file formats.

One part of the satisfying aspect of collecting music albums of the past was the tactile experience as well as the appreciation for the artwork that was an intrinsic part of the album. As is known in the art, LP albums were collected not only for the music content but also for the original works of art that were part of the packaging. These LP albums were traded amongst collectors and provided a technique to satisfy the aforementioned innate human characteristic of collection. Current media storage and distribution for the majority of produced music does not have a tangible device associated therewith. Most music is now stored electronically on devices such as but not limited to smart phones and there are no widely distributed digital media content devices that are configured to store and facilitate playback of music content. Another problem the music industry faces is the piracy of the digital media content and as such the monetization strategies of the music industry have faced significant headwinds.

It is intended within the scope of the present invention to provide a digital media content storage member that is configured to provide storage of digital media and further have an graphic art surface wherein the member is mateable with a digital media player that provides protected playback of the digital media.

### SUMMARY OF THE INVENTION

It is the object of the present invention to provide a digital media player and content storage member that are configured to provide distribution and playing of digital content wherein the digital media player and content storage member of the present invention are operationally exclusive.

Another object of the present invention is to provide a digital music distribution apparatus that includes a player and a media storage member wherein the player includes the necessary electronics to receive, store, transmit and manipulate data.

A further object of the present invention is to provide a digital media player and content storage member that are configured to provide distribution and playing of digital content wherein the digital media player of the present invention includes a first embodiment and a second embodiment wherein the first embodiment is an audio player and the second embodiment is a module that is operably coupled to a conventional audio player.

Still another object of the present invention is to provide a digital music distribution apparatus that includes a player and a media storage member wherein the media storage member incorporates electronic protection elements that ensure the ability to play the stored digital music only on the player of the present invention.

An additional object of the present invention is to provide a digital media player and content storage member that are configured to provide distribution and playing of digital content wherein the content storage member can be configured to facilitate recording of music thereon utilizing the media player of the present invention for the purpose of content creation.

Yet a further object of the present invention is to provide a digital music distribution apparatus that includes a player and a media storage member wherein the media storage member includes a graphic art surface that is configured to provide display of graphic artwork.

Another object of the present invention is to provide a digital media player and content storage member that are configured to provide distribution and playing of digital music wherein the graphic artwork surface further includes illumination elements.

An alternate object of the present invention is to provide a digital music distribution apparatus that includes a player and a media storage member wherein the media storage member is generally square in shape and includes a body having electrical contacts on the bottom edge thereof.

Still a further object of the present invention is to provide a digital media player and content storage member that are configured to provide distribution and playing of digital music wherein the content storage member body further has engagement notches on the opposing side edges of the body.

An additional object of the present invention is to provide a digital music distribution apparatus that includes a player and a media storage member wherein the present invention includes high bit depth and sample rates so as to provide a quality playback of music.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the player of the present invention; and

FIG. 2 is a front perspective view of the content storage member of the present invention.

### DETAILED DESCRIPTION

References now to the drawings submitted herewith, wherein various elements depicted therein are not necessarily drawn to scale and wherein through the views and figures like elements are referenced with identical reference numerals, there is illustrated a digital media apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

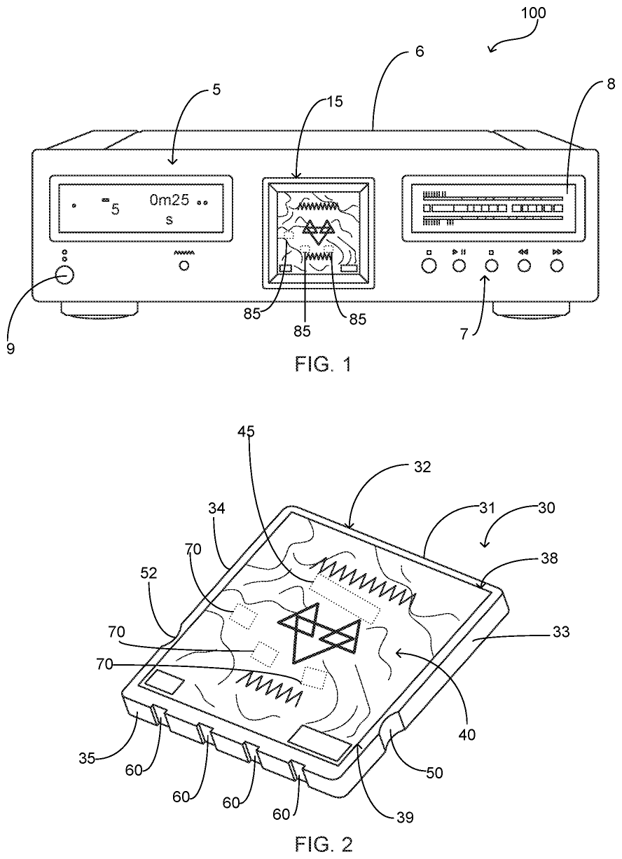

Referring now to the FIG. 1 submitted herewith, the digital media apparatus 100 includes player 5. Player 5 is formed in housing 6 wherein the housing has an interior volume(not particularly) illustrated herein that contains the necessary electronics to receive, store, manipulate and transmit data. Those skilled in the art will recognize the various electronic component combinations that could be utilized to achieve the desired functionality of the player 5 of the present invention to play audio data. The player 5 includes various controls 7 and at least one graphical interface 8 wherein the controls 7 provide manipulation of the audio data being transmitted and the graphical interface 8 displays various data such as but not limited to data pertaining to the audio data file being transmitted. It is contemplated within the scope of the present invention that the player 5 could have alternate quantities and types of controls 7 and further have various sizes and quantities of graphical interfaces 8. It is further contemplated within the scope of the present invention that the player 5 could be provided in alternate sizes and utilize power from either conventional one hundred and twenty volt or battery power sources. Additionally, the player 5 includes an audio input 9 wherein the audio input 9 provides the ability for a user of the digital media apparatus 100 to record audio to the media storage member 30 through operable coupling of a microphone or similar audio input device.

The player 5 has formed on the front wall thereof a media storage member receiving area 15. The media storage member receiving area 15 is mateably shaped so as to receive and retain therein the media storage member 30. The media storage member receiving area 15 is operable to receive and electronically couple the media storage member 30 with the player 5 so as to facilitate the transmission of audio data that is stored on the media storage member 30. While the media storage member receiving area 15 is illustrated as being square in shape herein, it should be understood within the scope of the present invention that the media storage member receiving area 15 is formed in the shape of the media storage member 30 which could be provided in alternate shapes.

Now referring in particular to FIG. 2 herein, the media storage member 30 is illustrated therein. The media storage member 30 utilizes flash storage such as but not limited to read only memory chips or random access memory chips to store digital audio data files. The media storage member 30 includes a housing 32 that is square in shape and is manufactured from a suitable durable material such as but not limited to plastic. The housing 32 is square in shape and includes opposing side edges 33,34, an upper edge 31 and a lower edge 35. While no particular size of the media storage member 30 is required, in a preferred embodiment of the present invention the media storage member 30 is sixty millimeters by sixty millimeters being four millimeters thick. It should be understood within the scope of the present invention that the media storage member 30 could be provided with a housing 32 having a different shape and size.

The housing 32 includes a graphic art display area 38 on the front thereof. The graphic art display area 38 is recessed so as to be below the upper edge 39 of the housing 32. The graphic art 40 secured in the graphic art display area 38 is manufactured from translucent plastic film or other suitable material and the recessed characteristic of the graphic art display area 38 ensures that the edges thereof are protected and not engaged so as to comprise the installation thereof during handling of the media storage member 30. The media storage member 30 further includes an illumination element 45. The illumination element 45 is positioned in the graphic art display area 38 and is operable to provide backlighting to the graphic art 40. The illumination element 45 is a conventional led light that is electrically coupled to the player 5 for the necessary power upon insertion of the media storage member 30. It is contemplated within the scope of the present invention that the media storage member 30 could have more than one illumination element 45 and could be placed in various locations in the graphic art display area 38.

The housing 32 has notches 50,52 formed in the opposing side edges 33,34 wherein the notches 50, 52 are proximate the lower edge 35. The notches 50, 52 are concave in form and provide an element for both engaging the housing 32 of the media storage member 30 by a user and further provide a technique to secure the media storage member 30 into the media storage member receiving area 15. While two notches 50, 52 are provided in the preferred embodiment, it is contemplated within the scope of the present invention that as few as one notch could be formed in the housing 32 in order to achieve the desired objective stated herein. Formed in the lower edge 35 of the housing 32 are a plurality of electrical contacts 60. The electrical contacts 60 are secured in the lower edge 35 utilizing suitable durable techniques and are manufactured from a suitable conductive material such as but not limited to copper. The electrical contacts 60 facilitate the transfer of power and data between the media storage member 30 and the player 5. It should be understood within the scope of the present invention that the media storage member 30 could be provided with alternate quantities of electrical contacts 60 and further could be located in alternate positions on the housing 32.

A feature of the digital media apparatus 100 is to provide protection of the copyrighted audio data files stored on the media storage member 30 by controlling the playing thereof to solely the player 5 of the present invention. The aforementioned inhibits the ability for an individual to play or transfer the audio data files without the player 5. This is focused on reducing the piracy that occurs in the music industry wherein current digital content can fairly easily be transferred and played with basic programming knowledge and on various generic audio devices. The media storage member 30 has embedded into the housing 32 a plurality of magnetic switches. The magnetic switches 70 are arranged in a pattern and are operable to magnetically engage opposing polarity switches 85 that are located in the media storage member receiving area 15 subsequent placement of the media storage member 30 therein. Ensuing alignment of the magnetic switches 70 with opposing polarity switches 85 secured in the media storage member receiving area 15, the circuitry of the media storage member 30 will be closed so as to then provide electrical current therethrough and enable operation thereof. While three magnetic switches 70 are illustrated herein, it is contemplated within the scope of the present invention that the housing 32 could have more or less than three magnetic switches 70. Furthermore, it should be understood that the arrangement and location of the magnetic switches 70 could vary. While magnetic switches 70 are discussed herein for a preferred technique of controlling playing of the content stored on the media storage member 30, it is contemplated within the scope of the present invention that alternate techniques could be utilized to achieve the desired functionality. By way of example but not limitation, pairs of physical switch engagements between the media storage member 30 and the media storage member receiving area 15 could be provided.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A digital media apparatus configured to facilitate playing of digital media comprising:
a media storage member, said media storage member having a housing, said housing being manufactured from plastic, said housing having a plurality of edges, said housing further having an upper surface, said housing having therein electronic storage chips, said media storage member further including control switches, said control switches inhibiting transmission of audio data files stored on said media storage member, said control switches operable to provide activation of the media storage member upon engagement with opposing mateable control switches;
a player, said player having a housing, said player having disposed within the housing electronics configured to receive, store, transmit and manipulate audio data, said housing of said player further having a media storage member receiving area, said media storage member receiving area configured to mateably receive and retain the media storage member; and
wherein said player further includes the opposing mateable control switches to operably engage the control switches of the media storage member.

2. The digital media apparatus as recited in claim 1, wherein the media storage member further includes a graphic art recess, said graphic art recess being formed in the upper surface of the housing of the media storage member.

3. The digital media apparatus as recited in claim 2, and further including a graphic art member, said graphic art member being disposed within the graphic art recess, said graphic art member being a translucent plastic material.

4. The digital media apparatus as recited in claim 3, and further including at least one illumination element, said at least one illumination element being disposed in said housing of said media storage member, said at least one illumination element configured to provide backlighting to the graphic art member.

5. The digital media apparatus as recited in claim 4, and further including at least one notch, said at least one notch being formed in one of the plurality of edges of the housing of said media storage member, said at least one notch operable to assist in handling of the media storage member and further secure in the media storage member receiving area.

6. The digital media apparatus as recited in claim 5, wherein said player further includes at least one audio input.

7. The digital media apparatus as recited in claim 6, wherein said control switches are magnets.

8. A digital media apparatus configured to facilitate playing of digital audio content wherein the digital audio content is restricted in transmission to the digital media apparatus comprising:
a media storage member, said media storage member having a housing, said housing being manufactured from plastic, said housing having opposing sides edges, an upper edge and a lower edge, said housing further having an upper surface, said housing further having a graphic art recess formed in the upper surface, said housing having therein electronic storage chips;
a first set of control switches, said first set of control switches being positioned in the housing of the media storage member, said first set of control switches configured to govern transmission of audio data files stored on said media storage member, said first set of control switches operable to provide activation of the media storage member and facilitate transmission of audio data files therefrom;
a player, said player having a housing, said player having disposed within the housing electronics configured to receive, store, transmit and manipulate audio data, said housing of said player further having a media storage member receiving area, said media storage member receiving area configured to mateably receive and retain the media storage member; and
a second set of control switches, said second set of control switches being located in the media storage member receiving area, said second set of control switches configured to engage the first set of control switches; and
wherein ensuing operable coupling of the first set of control switches and second set of control switches the media storage member and player facilitate transmission of audio data stored on the media storage member.

9. The digital media apparatus as recited in claim 8, and further including a graphic art member, said graphic art member being a translucent plastic film, said graphic art member being disposed in said graphic art recess.

10. The digital media apparatus as recited in claim 9, and further including at least one illumination element, said at least one illumination element being disposed in the graphic art recess, said at least one illumination element operable to backlight the graphic art member.

11. The digital media apparatus as recited in claim 10, and further including a first notch and a second notch, said first notch and said second notch being formed in the opposing side edges of the housing of the media storage member.

12. The digital media apparatus as recited in claim 11, and further including a plurality of electrical contacts, said plurality of electrical contacts being formed in the lower edge of the housing of the media storage member, said plurality of electrical contacts providing operable coupling of the media storage member with the player.

13. The digital media apparatus as recited in claim 12, wherein the media storage member is 60mm by 60mm and 4mm in thickness.

14. The digital media apparatus as recited in claim 13, wherein the first set of control switches and the second set of control switches include at least three switches in an arranged pattern.

15. The digital media apparatus as recited in claim 14, wherein said player further includes at least one audio input.

16. The digital media apparatus as recited in claim 15, wherein the first set of control switches and the second set of control switches are magnets.
